(19) United States
(12) Patent Application Publication
(10) Pub. No.: US 2018/0158415 A1
(43) Pub. Date: Jun. 7, 2018

(54) PIXEL CIRCUITS FOR MITIGATION OF HYSTERESIS

(71) Applicant: Ignis Innovation Inc., Waterloo (CA)

(72) Inventors: Gholamreza Chaji, Waterloo (CA); Yaser Azizi, Waterloo (CA)

(21) Appl. No.: 15/832,962

(22) Filed: Dec. 6, 2017

Related U.S. Application Data
(60) Provisional application No. 62/430,437, filed on Dec. 6, 2016.

(51) Int. Cl. G09G 3/3258

(52) U.S. Cl. CPC G09G 3/3258; G09G 2320/0209

(57) ABSTRACT

What is disclosed are display systems and methods of compensation of images produced by active matrix light emitting diode device (AMOLED) and other emissive displays. Anomalies in luminance produced by pixel circuits due to hysteresis effects are corrected through in-pixel compensation and resetting of the driving transistor.

### PRIORITY CLAIM

This application claims priority to U.S. Provisional Application No. 62/430,437, filed Dec. 6, 2016, which is hereby incorporated by reference in its entirety.

### FIELD OF THE INVENTION

The present disclosure relates to pixels circuits and signal timing of light emissive visual display technology, and particularly to systems and methods for programming and resetting pixels in active matrix light emitting diode device (AMOLED) and other emissive displays to mitigate hysteresis.

### BRIEF SUMMARY

According to a first aspect there is provided a display system comprising: an array of pixel circuits arranged in rows and columns, each pixel circuit including: a driving transistor; a storage capacitor coupled across a gate terminal and a first terminal of the driving transistor; a light emitting device coupled to a second terminal of the driving transistor; and a reset switch transistor coupled between a first reference potential and a node common to a first terminal of the storage capacitor and the gate terminal of the driving transistor; and a controller for driving each pixel circuit during each frame over a plurality of operation cycles for the pixel circuit including a programming cycle for programming the storage capacitor of the pixel circuit, and a reset cycle prior to the programming cycle for resetting the driving transistor of the pixel circuit, the controller resetting the driving transistor of the pixel circuit by activating the reset switch transistor of the pixel circuit during the reset cycle to expose the node of the pixel circuit to the reference potential which causes reverse biasing across the gate and first terminal of the driving transistor.

In some embodiments, the controller activates the reset switch transistor of the pixel circuit during the reset cycle of the pixel circuit with a control signal used for controlling a programming of another pixel circuit during the programming cycle of the another pixel circuit.

In some embodiments, the pixel circuit is of one row other than another row of the another pixel circuit. In some embodiments, the one row and the another row are adjacent rows.

In some embodiments, the controller programs the pixel circuit during the programming cycle of the pixel circuit using a write signal for the one row for controlling a first switch transistor for coupling a data line with the storage capacitor of the pixel circuit and using a read signal for the one row for controlling a second switch transistor for coupling a monitor line with the storage capacitor of the pixel circuit, and the control signal used for controlling the programming of the another pixel circuit is one of a write signal and a read signal for the another row.

In some embodiments, the controller further is for driving each pixel circuit over a plurality of operation cycles including a compensation cycle and a settling cycle after the programming cycle, during the compensation cycle the controller using the read signal to deactivate the second switch transistor to decouple the monitor line from the storage capacitor of the pixel circuit allowing the storage capacitor to discharge through the driving transistor of the pixel circuit during the compensation cycle.

Some embodiments further provide for a third switch transistor shared by at least a first and a second pixel circuit of the one row, in which the second switch transistor is shared by the at least a first and a second pixel circuit, in which the controller programs the at least a first and a second pixel circuit during the programming cycle using the read signal for the one row for controlling the shared second switch transistor for coupling the monitor line with the storage capacitors of the at least a first and a second pixel circuit, and in which the controller further is for driving each pixel circuit over a plurality of operation cycles including an emission cycle after the programming cycle, during the emission cycle the controller using an emission signal line to control the third switch transistor to couple the driving transistors of the at least a first and a second pixel circuit to the first reference potential.

In some embodiments, the controller programs the pixel circuit during the programming cycle of the first circuit using a write signal for the one row for controlling a first switch transistor for coupling a data line with the storage capacitor of the pixel circuit and for controlling a second switch transistor for coupling a monitor line with the storage capacitor of the pixel circuit, in which the control signal used for controlling the programming of the another pixel is a write signal for the another row.

Some embodiments further provide for a third switch transistor shared by at least a first and a second pixel circuit of the one row, in which the second switch transistor is shared by the at least a first and a second pixel circuit, in which the controller further is for driving each pixel circuit over a plurality of operation cycles including an emission cycle after the programming cycle, during the emission cycle the controller using an emission signal line to control the third switch transistor to couple the driving transistors of the at least a first and a second pixel circuit to the first reference potential.

According to another aspect, there is provided a method of driving a display system, the display system including an array of pixel circuits arranged in rows and columns, each pixel circuit including: a driving transistor; a storage capacitor coupled across a gate terminal and a first terminal of the driving transistor; a light emitting device coupled to a second terminal of the driving transistor; and a reset switch transistor coupled between a first reference potential and a node common to a first terminal of the storage capacitor and the gate terminal of the driving transistor; the method comprising: driving each pixel circuit during each frame over a plurality of operation cycles for the pixel circuit including a programming cycle and a reset cycle, comprising: during the programming cycle, programming the storage capacitor of the pixel circuit, and during a reset cycle prior to the programming cycle, resetting the driving transistor of the pixel circuit by activating the reset switch transistor of the pixel circuit during the reset cycle to expose the node of the pixel circuit to the reference potential which causes reverse biasing across the gate and first terminal of the driving transistor.

In some embodiments resetting the driving transistor comprises activating the reset switch transistor of the pixel circuit with a control signal used for controlling a programming of another pixel circuit during the programming cycle of the another pixel circuit.

Some embodiments further provide for programming the pixel circuit during the programming cycle using a write signal for the one row for controlling a first switch transistor for coupling a data line with the storage capacitor of the pixel circuit and using a read signal for the one row for controlling a second switch transistor for coupling a monitor line with the storage capacitor of the pixel circuit, in which the control signal used for controlling the programming of the another pixel circuit is one of a write signal and a read signal for the another row.

In some embodiments, the plurality of operation cycles includes a compensation cycle and a settling cycle, in which driving each pixel circuit further comprises after the programming cycle, during compensation cycle, deactivating the second switch transistor using the read signal to decouple the monitor line from the storage capacitor of the pixel circuit allowing the storage capacitor to discharge through the driving transistor of the pixel circuit during the compensation cycle.

Some embodiments further provide for, programming the pixel circuit during the programming cycle using a write signal for the one row for controlling a first switch transistor for coupling a data line with the storage capacitor of the pixel circuit and for controlling a second switch transistor for coupling a monitor line with the storage capacitor of the pixel circuit, in which the control signal used for controlling the programming of the another pixel is a write signal for the another row.

According to a further aspect there is provided a display system comprising: an array of pixel circuits arranged in rows and columns, each pixel circuit including: a driving transistor; a storage capacitor coupled across a gate terminal and a first terminal of the driving transistor; a light emitting device coupled to a second terminal of the driving transistor; and a switch transistor coupled between a reference voltage and a node common to a first terminal of the storage capacitor and the first terminal of the driving transistor; and a controller for driving each pixel circuit during each frame over a plurality of operation cycles for the pixel circuit including a programming cycle for programming the storage capacitor of the pixel circuit, and a reset cycle prior to the programming cycle for resetting the driving transistor of the pixel circuit, the controller resetting the driving transistor of the pixel circuit by activating the switch transistor of the pixel circuit during the reset cycle to expose the node of the pixel circuit to the reference voltage which is set to a voltage to cause reverse biasing across the gate and first terminal of the driving transistor.

In some embodiments, the controller programs the pixel circuit during the programming cycle of the pixel circuit by deactivating the switch transistor, activating a first switch transistor for coupling a data line with the storage capacitor and the gate terminal of the driving transistor of the pixel circuit and activating a second switch transistor for coupling a controllable reference potential with the node of the pixel circuit.

In some embodiments, the controller further is for driving each pixel circuit over a plurality of operation cycles including a compensation cycle and a settling cycle after the programming cycle, during the compensation cycle the controller deactivating the second switch transistor to decouple the controllable reference potential from the node of the pixel circuit allowing the storage capacitor to discharge through the driving transistor of the pixel circuit during the compensation cycle.

According to yet another aspect there is provided a method of driving a display system, the display system including an array of pixel circuits arranged in rows and columns, each pixel circuit including: a driving transistor; a storage capacitor coupled across a gate terminal and a first terminal of the driving transistor; a light emitting device coupled to a second terminal of the driving transistor; and a switch transistor coupled between a reference voltage and a node common to a first terminal of the storage capacitor and the first terminal of the driving transistor; the method comprising: driving each pixel circuit during each frame over a plurality of operation cycles for the pixel circuit including a programming cycle and a reset cycle, comprising: during the programming cycle, programming the storage capacitor of the pixel circuit, and during a reset cycle prior to the programming cycle, resetting the driving transistor of the pixel circuit by activating the switch transistor of the pixel circuit during the reset cycle to expose the node of the pixel circuit to the reference voltage which is set to a voltage to cause reverse biasing across the gate and first terminal of the driving transistor.

Some embodiments further provide for programming the pixel circuit during the programming cycle by deactivating the switch transistor, activating a first switch transistor for coupling a data line with the storage capacitor and the gate terminal of the driving transistor of the pixel circuit, and activating a second switch transistor for coupling a controllable reference potential with the node of the pixel circuit.

In some embodiments, the plurality of operation cycles includes a compensation cycle and a settling cycle, in which driving each pixel circuit further comprises after the programming cycle, during the compensation cycle, deactivating the second switch transistor to decouple the controllable reference potential from the node of the pixel circuit allowing the storage capacitor to discharge through the driving transistor of the pixel circuit during the compensation cycle.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 illustrates an example display system utilizing the methods and comprising the pixels disclosed;

FIG. 2A is a circuit diagram of a thin film transistor (TFT) forward biased;

FIG. 2B is a circuit diagram of a thin film transistor (TFT) reverse biased;

FIG. 3 circuit diagram of a four transistor single capacitor (4T1C) pixel circuit according to an embodiment with in-pixel compensation;

FIG. 4 is a timing diagram illustrating programming and driving of a 4T1C pixel circuit;

FIG. 5 is a circuit diagram of a five transistor single capacitor (5T1C) pixel circuit according to an embodiment;

FIG. 6 is a circuit diagram of a modified 5T1C pixel circuit according to a further embodiment;

FIG. 7 a timing diagram illustrating programming and driving of a 5T1C pixel circuits of FIGS. 5 and 6;

FIG. 8 is a circuit diagram illustrating a TFT sharing implementation of the 5T1C pixel circuit of FIG. 5;

FIG. 9 is a circuit diagram illustrating a TFT sharing implementation of the 5T1C pixel circuit of FIG. 6; and

FIG. 10 is a timing diagram illustrating an alternate programming and driving of the 4T1C pixel circuit of FIG. 3.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Many modern display technologies suffer from defects, variations, and non-uniformities, from the moment of fabrication, and can suffer further from aging and deterioration over the operational lifetime of the display, which result in the production of images which deviate from those which are intended. Methods of image calibration and compensation are used to correct for those defects in order to produce images which are more accurate, uniform, or otherwise more closely reproduce the image represented by the image data. Some displays suffer from hysteresis effects due to the trapping of carriers in the TFT channel of the driving transistor after being forward biased in saturation mode for a sufficient time. This affects the I-V characteristics of the TFT including its threshold voltage, which are exhibited as hysteresis effects which can affect the accuracy and uniformity of the display.

The display systems, pixels, and methods disclosed below address these issues through control timing and a reset cycle for the pixel circuits as described below.

While the embodiments described herein will be in the context of AMOLED displays it should be understood that the systems and methods described herein are applicable to any other display comprising pixels which might utilize current biasing, including but not limited to light emitting diode displays (LED), electroluminescent displays (ELD), organic light emitting diode displays (OLED), plasma display panels (PSP), among other displays.

It should be understood that the embodiments described herein pertain to systems and methods of calibration and compensation and do not limit the display technology underlying their operation and the operation of the displays in which they are implemented. The systems and methods described herein are applicable to any number of various types and implementations of various visual display technologies.

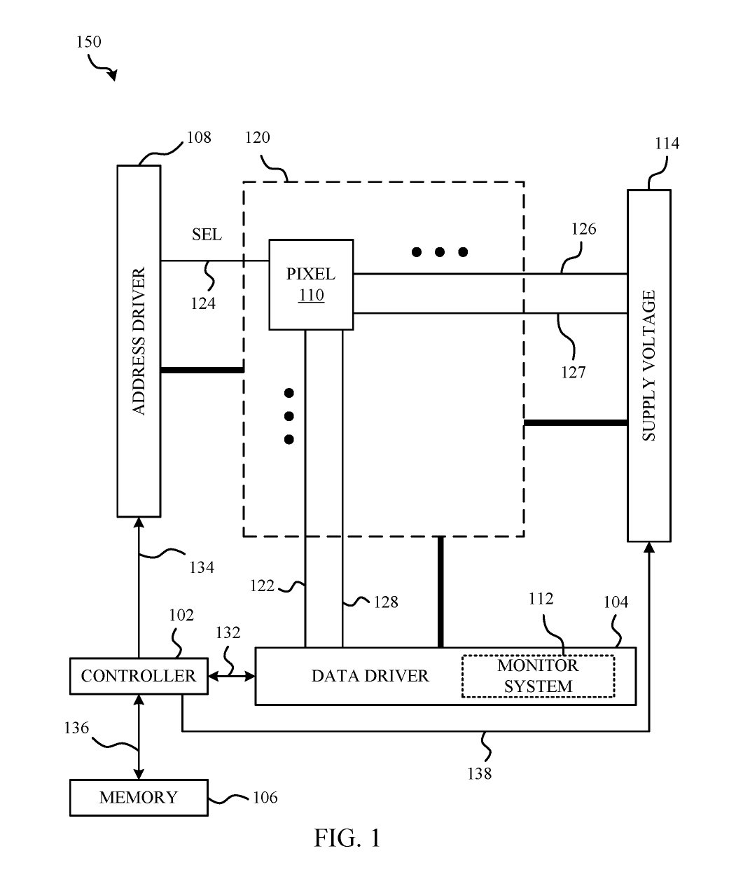

FIG. 1 is a diagram of an example display system 150 implementing the methods and pixel circuits described further below. The display system 150 includes a display panel 120, an address driver 108, a data driver 104, a controller 102, and a memory storage 106.

The display panel 120 includes an array of pixels 110 (only one explicitly shown) arranged in rows and columns. Each of the pixels 110 is individually programmable to emit light with individually programmable luminance values. The controller 102 receives digital data indicative of information to be displayed on the display panel 120. The controller 102 sends signals 132 to the data driver 104 and scheduling signals 134 to the address driver 108 to drive the pixels 110 in the display panel 120 to display the information indicated. The plurality of pixels 110 of the display panel 120 thus comprise a display array or display screen adapted to dynamically display information according to the input digital data received by the controller 102. The display screen can display images and streams of video information from data received by the controller 102. The supply voltage 114 provides a constant power voltage or can serve as an adjustable voltage supply that is controlled by signals from the controller 102. The display system 150 can also incorporate features from a current source or sink (not shown) to provide biasing currents to the pixels 110 in the display panel 120 to thereby decrease programming time for the pixels 110.

For illustrative purposes, only one pixel 110 is explicitly shown in the display system 150 in FIG. 1. It is understood that the display system 150 is implemented with a display screen that includes an array of a plurality of pixels, such as the pixel 110, and that the display screen is not limited to a particular number of rows and columns of pixels. For example, the display system 150 can be implemented with a display screen with a number of rows and columns of pixels commonly available in displays for mobile devices, monitor-based devices, and/or projection-devices. In a multichannel or color display, a number of different types of pixels, each responsible for reproducing color of a particular channel or color such as red, green, or blue, will be present in the display. Pixels of this kind may also be referred to as “subpixels” as a group of them collectively provide a desired color at a particular row and column of the display, which group of subpixels may collectively also be referred to as a “pixel”.

The pixel 110 is operated by a driving circuit of the pixel circuit that generally includes a driving transistor and a light emitting device. Hereinafter the pixel 110 may be referred to also as a “pixel circuit”. The light emitting device can optionally be an organic light emitting diode, but implementations of the present disclosure apply to pixel circuits having other electroluminescence devices, including current-driven light emitting devices and those listed above. The driving transistor in the pixel 110 can optionally be an n-type or p-type amorphous silicon thin-film transistor, but implementations of the present disclosure are not limited to pixel circuits having a particular polarity of transistor or only to pixel circuits having thin-film transistors. The pixel circuit 110 can also include a storage capacitor for storing programming information and allowing the pixel circuit 110 to drive the light emitting device after being addressed. Thus, the display panel 120 can be an active matrix display array.

As illustrated in FIG. 1, the pixel 110 illustrated as the top-left pixel in the display panel 120 is coupled to a select line 124 (also referred to as a write signal line), a supply line 126, a data line 122, and a monitor line 128. A read line and an emission control line may also be included for respectively controlling connections to the monitor line and providing additional control of emission from the pixel. In one implementation, the supply voltage 114 can also provide a second supply line to the pixel 110. For example, each pixel can be coupled to a first supply line 126 charged with ELVDD and a second supply line 127 coupled with ELVSS, and the pixel circuits 110 can be situated between the first and second supply lines to facilitate driving current between the two supply lines during an emission phase of the pixel circuit. It is to be understood that each of the pixels 110 in the pixel array of the display 120 is coupled to appropriate select lines, supply lines, data lines, and monitor lines. It is noted that aspects of the present disclosure apply to pixels having additional connections, such as connections to additional select lines, and to pixels having fewer connections.

With reference to the pixel 110 of the display panel 120, the select line 124 is provided by the address driver 108, and can be utilized to enable, for example, a programming operation of the pixel 110 by activating a switch or transistor to allow the data line 122 to program the pixel 110. The data line 122 conveys programming information from the data driver 104 to the pixel 110. For example, the data line 122 can be utilized to apply a programming voltage V_{DATA} or a programming current to the pixel 110 in order to program the pixel 110 to emit a desired amount of luminance. The programming voltage (or programming current) supplied by the data driver 104 via the data line 122 is a voltage (or current) appropriate to cause the pixel 110 to emit light with a desired amount of luminance according to the digital data received by the controller 102. The programming voltage (or programming current) can be applied to the pixel 110 during a programming operation of the pixel 110 so as to charge a storage device within the pixel 110, such as a storage capacitor, thereby enabling the pixel 110 to emit light with the desired amount of luminance during an emission operation following the programming operation. For example, the storage device in the pixel 110 can be charged during a programming operation to apply a voltage to one or more of a gate or a source terminal of the driving transistor during the emission operation, thereby causing the driving transistor to convey the driving current through the light emitting device according to the voltage stored on the storage device.

Generally, in the pixel 110, the driving current that is conveyed through the light emitting device by the driving transistor during the emission operation of the pixel 110 is a current that is supplied by the first supply line 126 and is drained to a second supply line 127. The first supply line 126 and the second supply line 127 are coupled to the voltage supply 114. The first supply line 126 can provide a positive supply voltage (e.g., the voltage commonly referred to in circuit design as “ELVDD”) and the second supply line 127 can provide a negative supply voltage (e.g., the voltage commonly referred to in circuit design as “ELVSS”). In some embodiments the positive supply voltage “ELVDD” is a controllable positive supply which may be set to provide different voltage levels including for example, reference voltages, and the standard ELVDD rail. Implementations of the present disclosure can be realized where one or the other of the supply lines (e.g., the supply line 127) is fixed at a ground voltage or at another reference voltage.

The display system 150 also includes a monitoring system 112. With reference again to the pixel 110 of the display panel 120, the monitor line 128 connects the pixel 110 to the monitoring system 112. The monitoring system 12 can be integrated with the data driver 104, or can be a separate stand-alone system. In particular, the monitoring system 112 can optionally be implemented by monitoring the current and/or voltage of the data line 122 during a monitoring operation of the pixel 110, and the monitor line 128 can be entirely omitted. The monitor line 128 allows the monitoring system 112 to measure a current or voltage associated with the pixel 110 and thereby extract information indicative of a degradation or aging of the pixel 110 or indicative of a temperature of the pixel 110. In some embodiments, display panel 120 includes temperature sensing circuitry devoted to sensing temperature implemented in the pixels 110, while in other embodiments, the pixels 110 comprise circuitry which participates in both sensing temperature and driving the pixels. For example, the monitoring system 112 can extract, via the monitor line 128, a current flowing through the driving transistor within the pixel 110 and thereby determine, based on the measured current and based on the voltages applied to the driving transistor during the measurement, a threshold voltage of the driving transistor or a shift thereof. In some implementations the monitor line 128 is used during a programming cycle to provide a second voltage V_{MON} used in addition to the programming voltage V_{DATA} to program the pixel.

The controller and 102 and memory store 106 together or in combination with a compensation block (not shown) use compensation data or correction data, in order to address and correct for the various defects, variations, and non-uniformities, existing at the time of fabrication, and optionally, defects suffered further from aging and deterioration after usage. In some embodiments, the correction data includes data for correcting the luminance of the pixels obtained through measurement and processing using an external optical feedback system. Some embodiments employ the monitoring system 112 to characterize the behavior of the pixels and to continue to monitor aging and deterioration as the display ages and to update the correction data to compensate for said aging and deterioration over time.

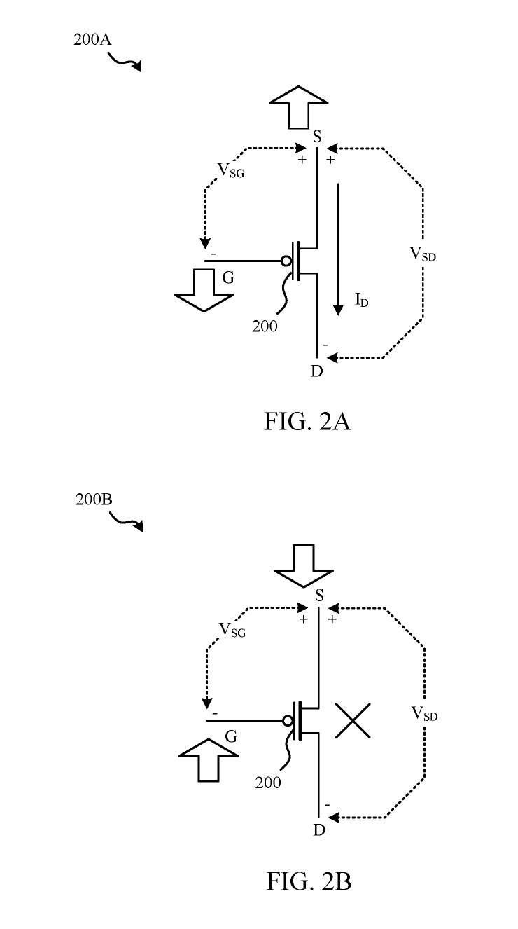

FIGS. 2A and 2B illustrate a transistor 200, in this case, a p-type thin film transistor (TFT), having a gate terminal G, a source terminal S, and a drain terminal D, which exhibits a hysteresis effect in response to biasing in the saturation region.

In FIG. 2A, the transistor 200 is depicted while being forward biased 200A in the saturation region, such that the gate voltage (V_{G}) is less than the voltage at the source (V_{S}) so that the source-gate voltage V_{SG} is greater than zero (V_{SG}>0) and such that the source-drain voltage V_{SD} is greater than the difference between the source-gate voltage V_{SG} and the threshold voltage (V_{TH}) of the transistor 200 (V_{SD}>V_{SG}−V_{TH}). As shown, when the transistor 200 is driven as illustrated in FIG. 2A, a driving current ID flows through the transistor 200.

When the transistor 200 is biased in this manner for a sufficient duration, which varies depending upon the transistor and various conditions of operation (in some cases, for example, a duration of 1 minute or greater is sufficient), short-term trapping of carriers in the TFT channel is caused which gives rise to temporary shifts in the threshold voltage of the transistor 200. Thereafter, while carriers remain so trapped, the transistor 200 will suffer from and exhibit hysteresis effects in its I-V response as different source-gate voltages V_{SG} are applied.

As depicted in FIG. 2B, to mitigate the effect of hysteresis on the I-V response of the transistor 200, the transistor 200 can be periodically driven 200B during a reset cycle with a negative driver voltage, such that the gate voltage (V_{G}) is greater than the voltage at the source (V_{S}) and thus the source-gate voltage is less than zero (V_{SG}<0). This triggers the release of carriers and hence a reversal of the short-term trapping of carriers, resetting the transistor 200 and its threshold voltage (V_{TH}), and mitigating hysteresis in the I-V response exhibited by the transistor 200. As shown in FIG. 2B, when transistor 200 is driven with a negative driver voltage 200B, no current flows the source S to the drain D. Some embodiments which follow utilize a reset cycle prior to each programming cycle to improve performance of the transistor 200.

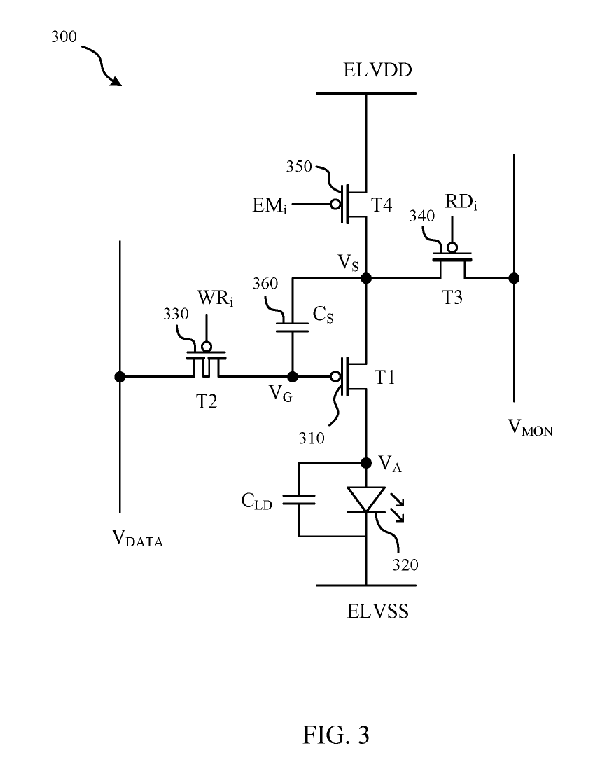

With reference to FIG. 3, the structure of a four transistor single capacitor (4T1C) pixel circuit 300 according to an embodiment utilizing in-pixel compensation will now be described. The 4T1C pixel circuit 300 corresponds, for example, to a single pixel 110 in the ith row of the display system 150 depicted in FIG. 1. The 4T1C pixel circuit 300 depicted in FIG. 3 is based on NMOS transistors. It should be understood that variations of this pixel and its functioning are contemplated and include different types of transistors (PMOS, NMOS, or CMOS) and different semiconductor materials (e.g. LTPS, Metal Oxide, etc.).

The 4T1C pixel circuit 300 includes a driving transistor 310 (T1), a light emitting device 320, a first switch transistor 330 (T2), a second switch transistor 340 (T3), a third switch transistor 350 (T4), and a storage capacitor 360 (Cs). Each of the driving transistor 310, the first switch transistor 330, the second switch transistor 340, and the third switch transistor 350 having first, second, and gate terminals, and each of the light emitting device 320 and the storage capacitor 360 having first and second terminals.

The gate terminal of the driving transistor 310 is coupled to a first terminal of the storage capacitor 360, while the first terminal of the driving transistor 310 is coupled to the second terminal of the storage capacitor 360, and the second terminal of the driving transistor 310 is coupled to the first terminal of the light emitting device 320. The gate terminal of the first switch transistor 330 is coupled to a write signal line (WRᵢ) of the ith row, while the first terminal of the first switch transistor 330 is coupled to a data line (V_{DATA}), and the second terminal of the first switch transistor 330 is coupled to the gate terminal of the driving transistor 310. A node common to the gate terminal of the driving transistor 310 and the storage capacitor 360 as well as the first switch transistor 330 is labelled by its voltage V_{G} in the figure. The gate terminal of the second switch transistor 340 is coupled to a read line (RDᵢ) of the ith row, while the first terminal of the second switch transistor 340 is coupled to a monitor line (V_{MON}), and the second terminal of the second switch transistor 340 is coupled to the second terminal of the storage capacitor 360. The gate terminal of the third switch transistor 350 is coupled to an emission signal line (EMᵢ) of the ith row, while the first terminal of the third switch transistor 350 is coupled to a first reference potential ELVDD, and the second terminal of the third switch transistor 350 is coupled to the second terminal of the storage capacitor 360. A node common to the second terminal of the storage capacitor 360, the driving transistor 310, the second switch transistor 340, and the third switch transistor 350 is labelled by its voltage V_{S} in the figure. The second terminal of the light emitting device 320 is coupled to a second reference potential ELVSS. A capacitance of the light emitting device 320 is depicted in FIG. 3 as C_{LD}. In some embodiments, the light emitting device 320 is an OLED.

The 4T1C pixel circuit 300 of FIG. 3, as will become apparent from the description of its functioning below, is capable of achieving a good level of in-pixel compensation which is useful for mitigating the hysteresis effects in the driving transistor 310.

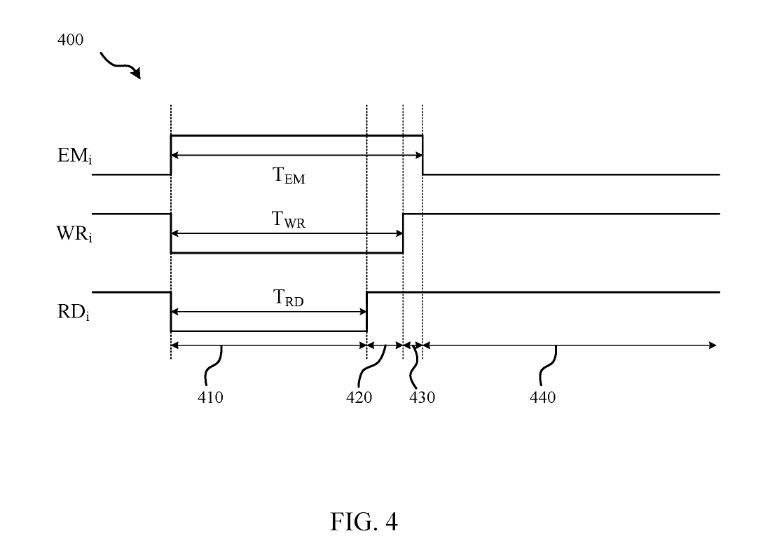

With reference also to FIG. 4, an example of a display timing 400 for the 4T1C pixel circuit 300 depicted in FIG. 3 will now be described. The complete display timing 400 occurs typically once per frame and includes a programming cycle 410, a calibration cycle 420, a settling cycle 430, and an emission cycle 440. During the programming cycle 410 over a period T_{RD}, the read signal (RDᵢ) and write signal (WRᵢ) are held low while the emission (EMᵢ) signal is held high. The emission signal (EMᵢ) is held high throughout the programming, calibration, and settling cycles 410 420 430 to ensure the third switch transistor 350 remains OFF during those cycles (T_{EM}).

During the programming cycle 410 the first switch transistor 330 and the second switch transistor 340 are both ON. The voltage of the storage capacitor 360 and therefore the voltage V_{SG} of the driving transistor 310 is charged to a value of V_{MON}−V_{DATA} where V_{MON} is a voltage of the monitor line and V_{DATA} is a voltage of the data line. These voltages are set in accordance with a desired programming voltage for causing the pixel 300 to emit light at a desired luminance according to image data.

At the beginning of the calibration cycle 420, the read signal (RDᵢ) goes high to turn OFF the second switch transistor 340 to discharge some of the voltage (charge) of the storage capacitor 360 through the driving transistor 310. The amount discharged is a function of the characteristics of the driving transistor 310. For example, if the driving transistor 310 is “strong”, the discharge occurs relatively quickly and relatively more charge is discharged from the storage capacitor 360 through the driving transistor 310 during the fixed duration of the calibration cycle 420. On the other hand, if the driving transistor 310 is “weak”, the discharge occurs relatively slowly and relatively less charge is discharged from the storage capacitor 360 through the driving transistor 310 during the calibration cycle 420. As a result, the voltage (charge) stored in the storage capacitor 360 (V_{P}) is reduced comparatively more for relatively strong driving transistors versus comparatively less for relatively weak driving transistors, thereby providing some compensation for non-uniformity and variations in the driving transistors across the display whether due to variations in fabrication, variations in degradation over time, or variations due to hysteresis in the temporary threshold voltage of the driving transistor 310.

After the calibration cycle 420, a settling cycle 430 is performed prior to the emission. During the settling cycle 430 the second and third switch transistors 340, 350 remain OFF, while the write signal (WRᵢ) goes high to also turn OFF the first switch transistor 330. After completion of the duration of the settling cycle 430 at the start of the emission cycle 440, the emission signal (EMᵢ) goes low turning ON the third switch transistor 350 allowing current to flow through the light emitting device 320 according to the calibrated stored voltage on the storage capacitor 360.

Although the pixel 300 circuit is capable of achieving in-pixel compensation including that related to hysteresis to a good level for high and medium grayscales, low grayscale compensation may be insufficient to meet high-end uniformity specifications.

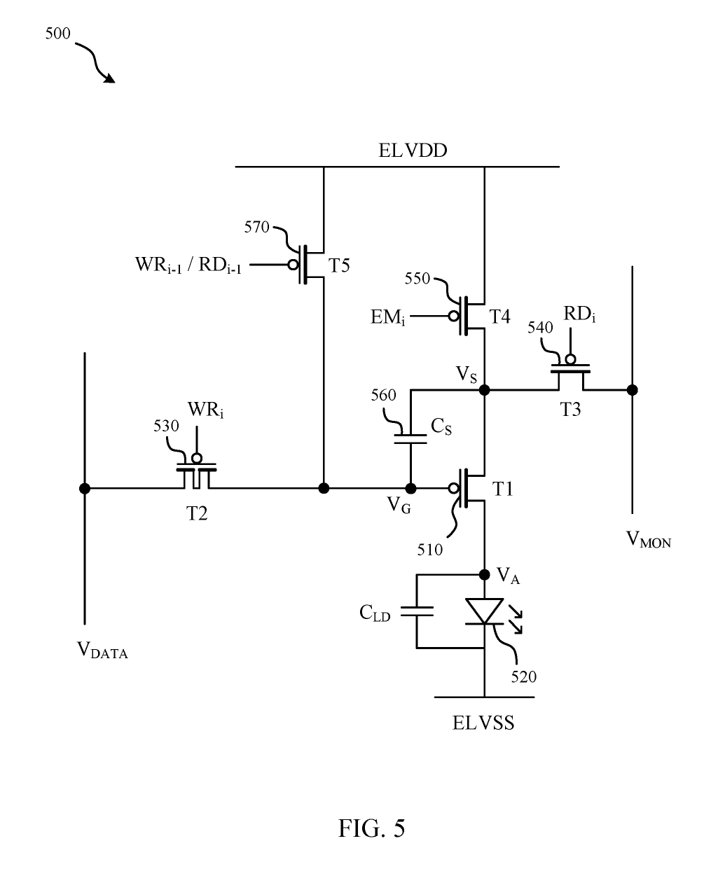

With reference to FIG. 5, the structure of a five transistor, single capacitor (5T1C) pixel circuit 500 according to an embodiment will now be described. The 5T1C pixel circuit 500 corresponds, for example, to a single pixel 110 in the ith row of the display system 150 depicted in FIG. 1. The 5T1C pixel circuit 500 depicted in FIG. 5 is based on NMOS transistors. It should be understood that variations of this pixel and its functioning are contemplated and include different types of transistors (PMOS, NMOS, or CMOS) and different semiconductor materials (e.g. LTPS, Metal Oxide, etc.).

The 5T1C pixel circuit 500 includes a driving transistor 510 (T1), a light emitting device 520, a first switch transistor 530 (T2), a second switch transistor 540 (T3), a third switch transistor 550 (T4), and a storage capacitor 560 (Cs) in substantially the same configuration as that of the 4T1C pixel circuit 300 of FIG. 3. The 5T1C pixel circuit 500 also includes a reset switch transistor 570 (T5) coupled between ELVDD and a node between the first switch transistor 530 and the storage capacitor 560.

The gate terminal of the driving transistor 510 is coupled to a first terminal of the storage capacitor 560, while the first terminal of the driving transistor 510 is coupled to the second terminal of the storage capacitor 560, and the second terminal of the driving transistor 510 is coupled to the first terminal of the light emitting device 520. The gate terminal of the first switch transistor 530 is coupled to a write signal line (WRᵢ) of the ith row, while the first terminal of the first switch transistor 530 is coupled to a data line (V_{DATA}), and the second terminal of the first switch transistor 530 is coupled to the gate terminal of the driving transistor 510. A node common to the gate terminal of the driving transistor 510 and the storage capacitor 560 as well as the first switch transistor 530 is labelled by its voltage V_{G} in the figure. The gate terminal of the second switch transistor 540 is coupled to a read line (RDᵢ) of the ith row, while the first terminal of the second switch transistor 540 is coupled to a monitor line (V_{MON}), and the second terminal of the second switch transistor 540 is coupled to the second terminal of the storage capacitor 560. The gate terminal of the third switch transistor 550 is coupled to an emission signal line (EMᵢ) of the ith row, while the first terminal of the third switch transistor 550 is coupled to a first reference potential ELVDD, and the second terminal of the third switch transistor 550 is coupled to the second terminal of the storage capacitor 560. A node common to the second terminal of the storage capacitor 560, the driving transistor 510, the second switch transistor 540, and the third switch transistor 550 is labelled by its voltage V_{S} in the figure. The second terminal of the light emitting device 520 is coupled to a second reference potential ELVSS. A capacitance of the light emitting device 520 is depicted in FIG. 5 as C_{LD}. In some embodiments, the light emitting device 520 is an OLED.

As mentioned above, the 5T1C pixel circuit 500 includes a reset switch transistor 570 coupled between the gate terminal of the drive transistor 510 and the first reference potential ELVDD. The first terminal of the reset switch transistor 570 is coupled to the first reference potential ELVDD and the second terminal of the reset switch transistor 570 is coupled to the node V_{G} common to the first switch transistor 530, the storage capacitor 560, and the driving transistor 510. The gate terminal of the reset switch transistor 570 is coupled to a read or write signal line of a different row, for example, the read line RDᵢ₋₁ of the (i−1)th row or the write signal line WRᵢ₋₁ of the (i−1)th row. The 5T1C pixel circuit 500 is capable of achieving both a good level of in-pixel compensation if so driven (which is useful for mitigating the hysteresis effects in the driving transistor 510) as well as being capable of releasing charges trapped in the channel of the driving transistor 510 through the reset cycle described further below.

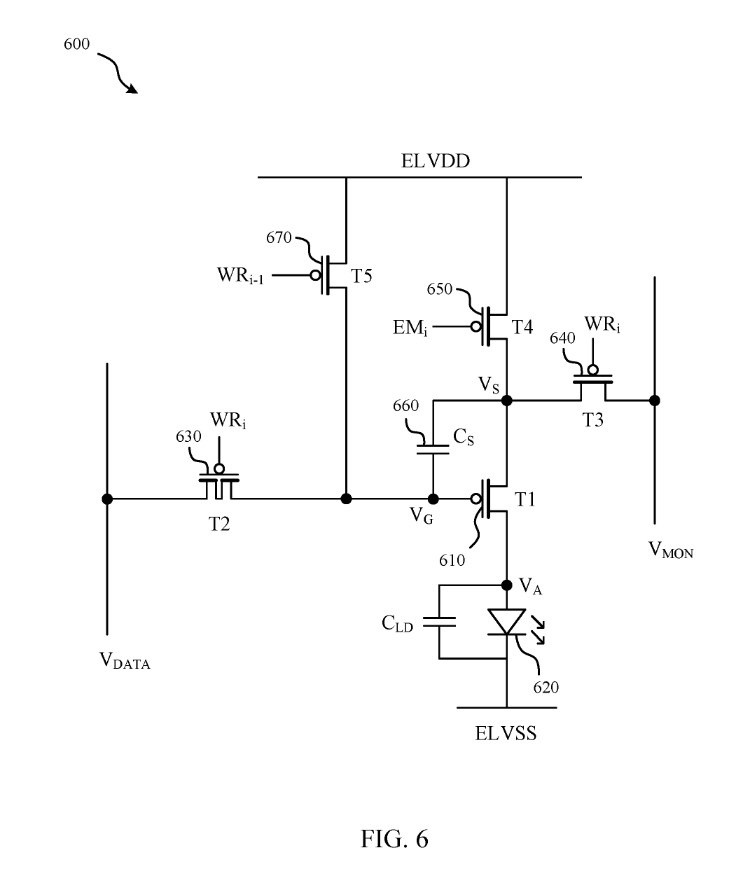

With reference to FIG. 6, the structure of a modified implementation of a five transistor, single capacitor (5T1C) pixel circuit 600 according to an embodiment will now be described. The modified 5T1C pixel circuit 600 corresponds, for example, to a single pixel 110 in the ith row of the display system 150 depicted in FIG. 1. The modified 5T1C pixel circuit 600 depicted in FIG. 6 is based on NMOS transistors. It should be understood that variations of this pixel and its functioning are contemplated and include different types of transistors (PMOS, NMOS, or CMOS) and different semiconductor materials (e.g. LTPS, Metal Oxide, etc.).

The modified 5T1C pixel circuit 600 includes a driving transistor 610 (T1), a light emitting device 620, a first switch transistor 630 (T2), a second switch transistor 640 (T3), a third switch transistor 650 (T4), a storage capacitor 660 (Cs), and a reset switch transistor 670 (T5) in substantially the same configuration as that of the 5T1C pixel circuit 500 of FIG. 5. The modified 5T1C pixel circuit 600 differs from the pixel circuit 500 only in that the gate terminal of the second switch transistor 640 is coupled to the write signal line (WRᵢ) of the ith row (to which the gate terminal of the first switch transistor 630 is also coupled), and the gate terminal of the reset switch transistor 670 is coupled to a write signal line of a different row, namely, the write signal line WRᵢ₋₁ of the (i−1)th row. This simplifies row (gate) control signals required per row of pixels of the display system 150.

The modified 5T1C pixel circuit 600, in a similar manner as the 5T1C 500 pixel circuit is capable of releasing charges trapped in the channel of the driving transistor 510 through the reset cycle described below.

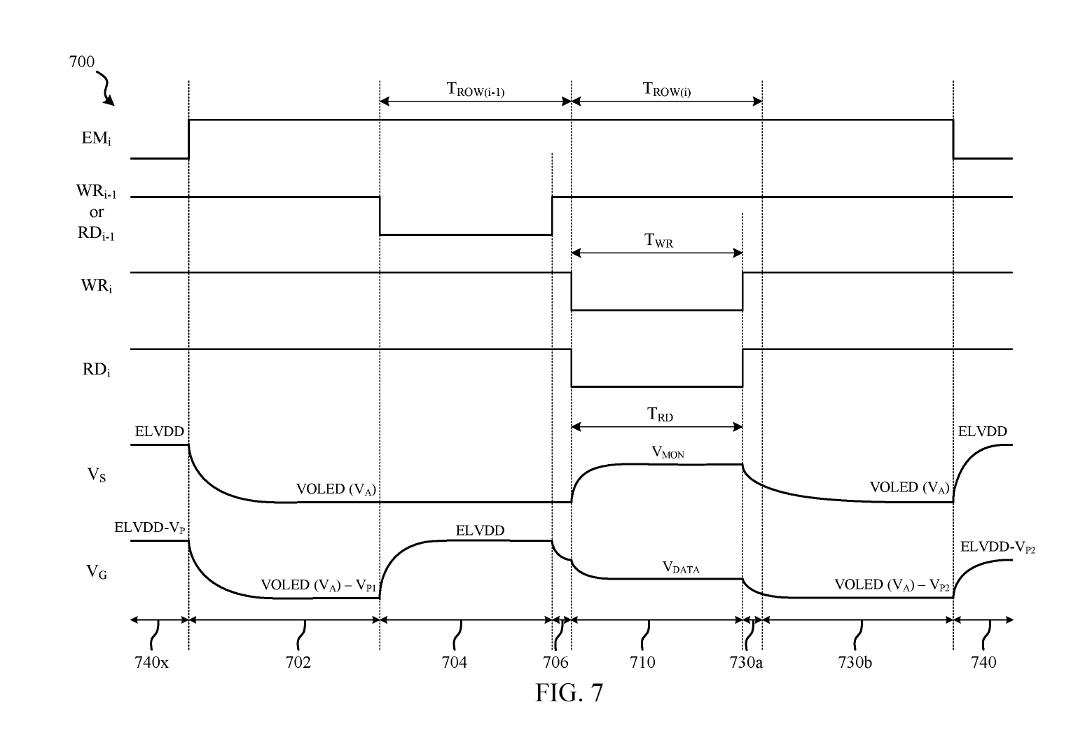

With reference also to FIG. 7, an example of a display timing 700 for 5T1C pixel circuits 500 and 600 of the ith row depicted in FIGS. 5-6 will now be described. The complete display timing 700 occurs typically once per frame and includes a post-emission settling cycle 702 (which occurs after a previous emission cycle 740x of a previous frame), a reset cycle 704, a first settling cycle 706, a programming cycle 710, first and second pre-emission settling cycles 730a, 730b, and an emission cycle 740.

At the end of the previous emission cycle 740x and the beginning of the post-emission settling cycle 702, the emission signal is (EMᵢ) is switched from low to high in order to turn OFF the third switch transistor 550, 650. During non-emission cycles 702, 704, 706, 710, 730a, 730b the emission (EMᵢ) signal is held high to ensure the third switch transistor 550 or 650 remains OFF during those cycles.

During the post-emission settling cycle 702 each of the transistors of the pixel circuit 500 600 is OFF allowing the voltage V_{S} to settle to V_{OLED} (the turn on voltage of the light emitting device 520 620), while the voltage V_{G} to settle to the voltage of the light emitting device minus a voltage on the storage capacitor 560 660 related to a pixel programming of the pixel during the previous frame (V_{OLED}−V_{P1}).

After a duration of the post-emission settling cycle 702, a sufficient settling time for V_{S} to settle to a low voltage, the write or read signal controlling the reset switch transistor 570 670, namely read signal RDᵢ₋₁ for the (i−1)th row, or write signal WRᵢ₋₁ for the (i−1)th row, switches from high to low, turning the reset switch transistor 570 670 ON, which charges node V_{G} up to ELVDD during the reset cycle 704. Since V_{S} has been discharged to a low voltage of V_{OLED} which is much less than ELVDD, during reset cycle 704 V_{SG} goes less than zero, the driving transistor 510 610 becomes negatively biased which triggers the release of carriers and hence reversal of the short-term trapping of carriers, resetting the driving transistor 510 610 and its threshold voltage (V_{TH}), and mitigating hysteresis in the I-V response exhibited by the driving transistor 510 610 when it is programmed in the following programming cycle 710. The negative biasing utilizing the ELVDD rail is programming independent and provides a high magnitude of reverse biasing for effective release of carriers and hence reduction of hysteresis effects.

After the reset cycle 704, the read signal RDᵢ₋₁ for the (i−1)th row, or write signal WRᵢ₋₁ for the (i−1)th row, switches from low to high, turning the reset switch transistor 570 670 OFF. For a relatively short first settling cycle 706, each of the transistors of the pixel circuit 500 600 are OFF. Following the first settling cycle 706, during the programming cycle 710, both the first switch transistor 530 630 and the second switch transistor 540 640 are turned ON.

For embodiments which include distinct read RD and write WR control signals, such as for the 5T1C pixel circuit 500, the read signal RDᵢ for the ith row, and the write signal WRᵢ for the ith row both switch from high to low, turning both the first switch transistor 530 and the second switch transistor 540 ON. For embodiments with only a write signal WR such as for the 5T1C pixel circuit 600, the write signal WRᵢ for the ith row switches from high to low, turning both the first switch transistor 630 and the second switch transistor 640 ON.

This exposes the first terminal of the storage capacitor 560 660 and the node V_{G} to V_{DATA} on the data line, and exposes the second terminal of the storage capacitor 560 660 and the node V_{S} to the voltage V_{MON} on the monitor line.

Over the duration that the first switch transistor 530 is ON (T_{WR}), V_{G} is charged to V_{DATA}, and over the duration that the second switch transistor 540 is ON (T_{RD}), V_{S} is charged to V_{MON}. In embodiments with only write signals WRᵢ, both the first and second switch transistors 630 640 are ON during T_{WR}, during which time V_{G} is charged to V_{DATA} and V_{S} is charged to V_{MON}.

In some embodiments, the first switch transistor 530 630 and the second switch transistor 540 640 are turned OFF at the same time at the end of the programming cycle 710. In embodiments with separate WRᵢ and RDᵢ signals such as the 5TC1 pixel circuit 500, the timing of T_{WR} and T_{RD} may be different, and such that T_{RD}<T_{WR}<T_{RWOW(i)} (where T_{ROW(i)} is the total duration of the programming cycle 710) so as to provide the programming and compensation cycles and the in-pixel compensation described in association with the embodiment depicted in FIG. 3 and FIG. 4.

Once both of the first switch transistor 530 630 and the second switch transistor 540 640 are turned OFF, after the end of the programming cycle 710, is a first pre-emission settling cycles 730a, followed by a second pre-emission settling cycle 730b during which each transistor of the 5T1C pixel circuit 500 600 are OFF, allowing the voltage V_{S} to settle at V_{OLED}, and allowing the voltage at V_{G} to settle at V_{OLED}−V_{P2}, where V_{P2} is related to the programming voltage (V_{MON}−V_{DATA}) and any shift caused by the threshold voltage and any in-pixel compensation. The reset cycle should reduce any hysteresis effects on that threshold voltage and any in-pixel compensation should also reduce the effects of other variations in threshold voltage (such as variations in fabrication) so that V_{P2} more closely matches the desired programming.

Finally, at the beginning of the emission cycle 740, the emission (EMᵢ) signal is switched from high to low to turn ON the third switch transistor 550 or 650.

The same token used for programming a pixel in one row (i−1) over either the WRᵢ₋₁ or RDᵢ₋₁ signal lines (of duration T_{WR} or T_{RD}), is re-used to control the reset switch transistor 570, 670 of a pixel in another row (i). The timing generally for programming and settling row i−1 (T_{ROW(i-1)}), occurs just prior to but for the same duration as that of the programming and settling of row i (T_{ROW(i)}).

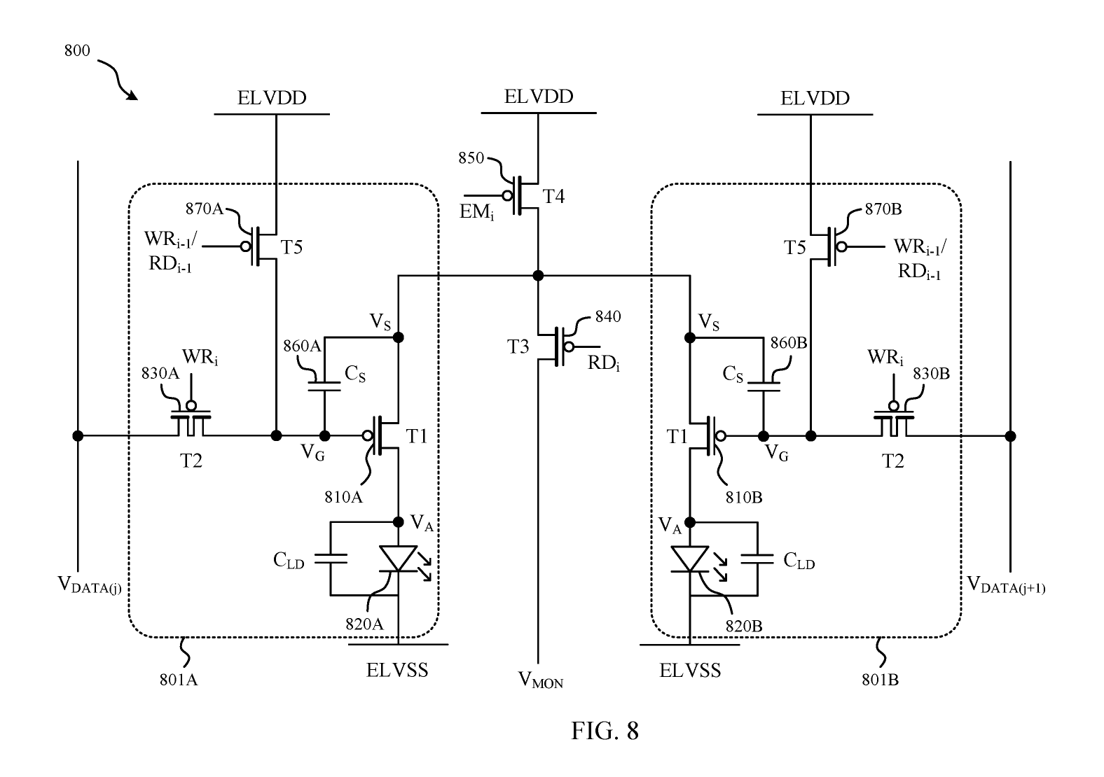

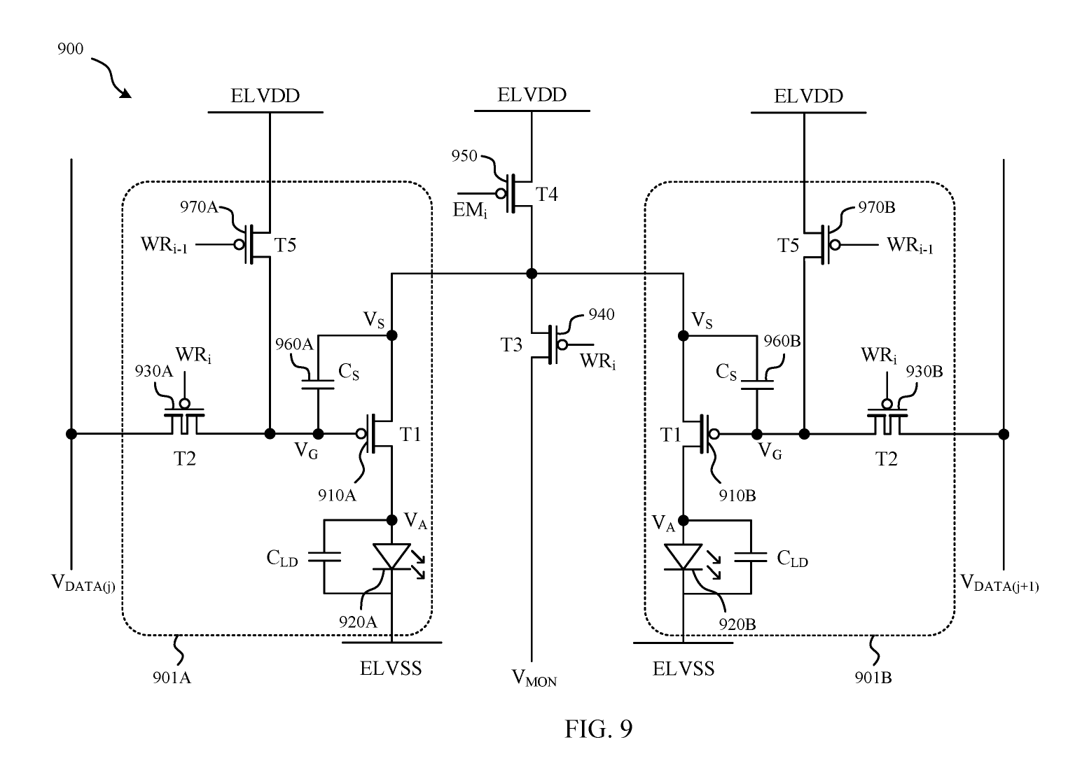

With reference also to FIG. 8 and FIG. 9, an implementation of 5T1C pixel circuits 500 600 in which the second and third switch transistors are shared between two or more adjacent 5T1C pixels will now be described.

With reference to FIG. 8, a first subpixel 801A and second subpixel 801B each include the a first switch transistor 830A 830B, a driving transistor 810A 810B, a light emitting device 820A 820B, and a reset transistor 870A 870B as shown and described in association with the 5T1C pixel circuit 500 of FIG. 5. The first and second subpixels 801A 801B, however, share the node V_{S} common and between the driving transistors 810A 810B and the storage capacitors 860A 860B. Also shared between the first and second subpixels 801A 801B, are a third switch transistor 850 (T4) coupled between the node V_{S} and ELVDD, and a second switch transistor 840 (T3) coupled between the node V_{S} and the monitor line V_{MON}. The gate terminal of the third switch transistor 850 is coupled to an emission signal line (EMᵢ) of the ith row, while the first terminal of the third switch transistor 850 is coupled to the first reference potential ELVDD, and the second terminal of the third switch transistor 850 is coupled to node V_{S} which is common to the second terminal of the storage capacitors 860A 860B. The gate terminal of the second switch transistor 840 is coupled to a read line (RDᵢ) of the ith row, while the first terminal of the second switch transistor 840 is coupled to a monitor line (V_{MON}), and the second terminal of the second switch transistor 840 is also coupled to the node V_{S}.

Each of the first and second subpixels 801A 801B functions the same as the 5T1C pixel circuit 500 of FIG. 5 and according to the timing illustrated in FIG. 7 and discussed above. Utilizing the configuration of FIG. 8 in a design implementation where pixel area is limited by the TFT device count, sharing of the second and third switch transistors 840 850 between two or more adjacent sub-pixels reduces the effective device count per subpixel.

With reference to FIG. 9, a first subpixel 901A and second subpixel 901B each include a first switch transistor 930A 930B, a driving transistor 910A 910B, a light emitting device 920A 920B, and a reset transistor 970A 970B as shown and described in association with the 5T1C pixel circuit 600 of FIG. 6. The first and second subpixels 901A 901B, however, share the node V_{S} common and between the driving transistors 910A 910B and the storage capacitors 960A 960B. Also shared between the first and second subpixels 901A 901B, are a third switch transistor 950 (T4) coupled between the node V_{S} and ELVDD, and a second switch transistor 940 (T3) coupled between the node V_{S} and the monitor line V_{MON}. The gate terminal of the third switch transistor 950 is coupled to an emission signal line (EMᵢ) of the ith row, while the first terminal of the third switch transistor 950 is coupled to the first reference potential ELVDD, and the second terminal of the third switch transistor 950 is coupled to node V_{S} which is common to the second terminal of the storage capacitors 960A 960B. The gate terminal of the second switch transistor 940 is coupled to a write signal line (WRᵢ) of the ith row, while the first terminal of the second switch transistor 940 is coupled to a monitor line (V_{MON}), and the second terminal of the second switch transistor 940 is also coupled to the node V_{S}.

Each of the first and second subpixels 901A 901B functions the same as the 5T1C pixel circuit 600 of FIG. 6 and according to the timing illustrated in FIG. 7 and discussed above. Utilizing the configuration of FIG. 9 in a design implementation where pixel area is limited by the TFT device count, sharing of the second and third switch transistors 940 950 between two or more adjacent sub-pixels reduces the effective device count per subpixel. Additionally, as with the embodiment of FIG. 6, the utilization of write signal line WRᵢ and WRᵢ₋₁ only (without the use of read lines RDᵢ and RDᵢ₋₁) simplifies row (gate) control signals required per row of pixels of the display system 150.

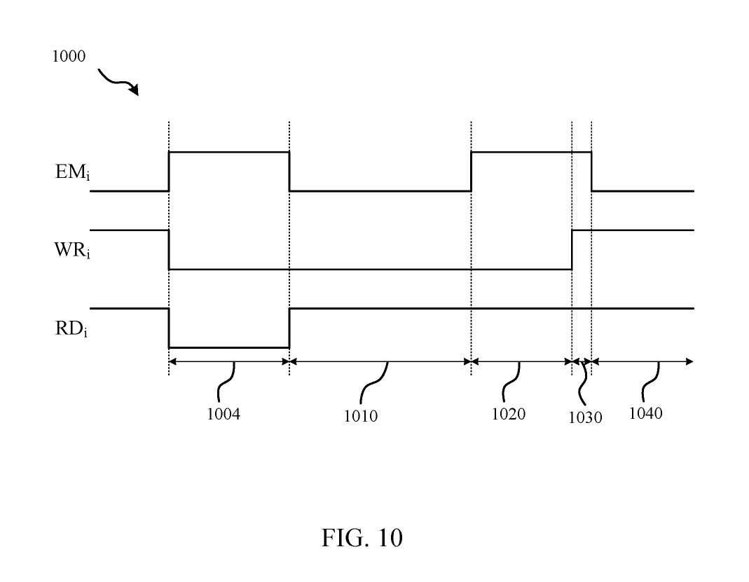

With reference to FIG. 10, an alternate example of a display timing 1000 for the 4T1C pixel circuit 300 depicted in FIG. 3 which includes both reset and in pixel compensation will now be described. The complete display timing 1000 occurs typically once per frame and includes a rest cycle 1004, a programming cycle 1010, a compensation cycle 1020, a settling cycle 1030, and an emission cycle 1040. The write signal (WRᵢ) is held low throughout the reset, programming, and calibration cycles 1004 1010 1020, keeping the data line voltage V_{DATA} coupled to V_{G}. For the embodiment of FIG. 4, the supply voltage ELVDD of the 4T1C pixel circuit 300 of FIG. 3 is controllable.

During the reset cycle 1004, the emission signal (EMᵢ) is held high while the read signal (RDᵢ) is held low ensuring the third switch transistor 350 is OFF and the second switch transistor 340 is ON exposing the node V_{S} to the voltage on the monitor line V_{MON}. Also during the reset cycle 1004 the voltage on the monitor line V_{MON} is set to 0 volts and the voltage of the data line is set at a pixel data level (typically 6 to 9 volts), giving rise to a negative V_{SG} of 6 to 9 volts. The driving transistor 310 being negatively biased triggers the release of carriers and hence reversal of the short-term trapping of carriers, resetting the driving transistor 310 and its threshold voltage (V_{TH}), and mitigating hysteresis in the I-V response exhibited by the driving transistor 310 when it is programmed in the following programming cycle 1010.

During the programming cycle 1010 the read signal (RDᵢ) goes high turning OFF the second switch transistor 340 and the emission signal (EMᵢ) goes low turning ON the third switch transistor 350. The voltage ELVDD is set to a reference voltage V_{REF} (similar to, for example, the reference voltage V_{MON} described in association with FIG. 4, and provided on the monitor line during programming cycle 410). Since the first switch transistor 330 and the third switch transistor 350 are both ON, the voltage of the storage capacitor 360 and therefore the voltage V_{SG} of the driving transistor 310 is charged to a value of V_{REF}−V_{DATA}. These voltages are set in accordance with a desired programming voltage for causing the pixel 300 to emit light at a desired luminance according to image data.

At the beginning of the calibration cycle 1020, the emission signal (EMᵢ) goes high to turn OFF the third switch transistor 350 to discharge some of the voltage (charge) of the storage capacitor 360 through the driving transistor 310. The amount discharged is a function of the characteristics of the driving transistor 310. For example, if the driving transistor 310 is “strong”, the discharge occurs relatively quickly and relatively more charge is discharged from the storage capacitor 360 through the driving transistor 310 during the fixed duration of the calibration cycle 420. On the other hand, if the driving transistor 310 is “weak”, the discharge occurs relatively slowly and relatively less charge is discharged from the storage capacitor 360 through the driving transistor 310 during the calibration cycle 1020. As a result, the voltage (charge) stored in the storage capacitor 360 (V_{P}) is reduced comparatively more for relatively strong driving transistors versus comparatively less for relatively weak driving transistors, thereby providing some compensation for non-uniformity and variations in the driving transistors across the display whether due to variations in fabrication, variations in degradation over time, or variations due to hysteresis in the temporary threshold voltage of the driving transistor 310.

After the calibration cycle 1020, a settling cycle 1030 is performed prior to the emission. During the settling cycle 1030 the second and third switch transistors 340, 350 remain OFF, while the write signal (WRᵢ) goes high to also turn OFF the first switch transistor 330. After completion of the duration of the settling cycle 1030 at the start of the emission cycle 1040, ELVDD is set to the standard positive reference ELVDD rail instead of V_{REF}, and the emission signal (EMᵢ) goes low turning ON the third switch transistor 350 allowing current to flow through the light emitting device 320 according to the calibrated stored voltage on the storage capacitor 360.

Driven in this manner, in conjunction with a controllable positive reference potential ELVDD, the pixel 300 circuit is capable of achieving in-pixel compensation including that related to hysteresis to a good level for high and medium grayscales, as well as performing a reset cycle for directly reducing hysteresis effects on the threshold voltage of the driving transistor 310 caused by trapped carriers, which better address low grayscale compensation required to meet high-end uniformity specifications.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A display system comprising:
an array of pixel circuits arranged in rows and columns, each pixel circuit including:
a driving transistor;
a storage capacitor coupled across a gate terminal and a first terminal of the driving transistor;
a light emitting device coupled to a second terminal of the driving transistor; and
a reset switch transistor coupled between a first reference potential and a node common to a first terminal of the storage capacitor and the gate terminal of the driving transistor; and
a controller for driving each pixel circuit during each frame over a plurality of operation cycles for the pixel circuit including a programming cycle for programming the storage capacitor of the pixel circuit, and a reset cycle prior to the programming cycle for resetting the driving transistor of the pixel circuit, the controller resetting the driving transistor of the pixel circuit by activating the reset switch transistor of the pixel circuit during the reset cycle to expose the node of the pixel circuit to the reference potential which causes reverse biasing across the gate and first terminal of the driving transistor.

2. The display system of claim 1 wherein the controller activates the reset switch transistor of the pixel circuit during the reset cycle of the pixel circuit with a control signal used for controlling a programming of another pixel circuit during the programming cycle of the another pixel circuit.

3. The display system of claim 2 wherein the pixel circuit is of one row other than another row of the another pixel circuit.

4. The display system of claim 3 wherein the one row and the another row are adjacent rows.

5. The display system of claim 4 wherein the controller programs the pixel circuit during the programming cycle of the pixel circuit using a write signal for the one row for controlling a first switch transistor for coupling a data line with the storage capacitor of the pixel circuit and using a read signal for the one row for controlling a second switch transistor for coupling a monitor line with the storage capacitor of the pixel circuit, wherein the control signal used for controlling the programming of the another pixel circuit is one of a write signal and a read signal for the another row.

6. The display system of claim 5 wherein the controller further is for driving each pixel circuit over a plurality of operation cycles including a compensation cycle and a settling cycle after the programming cycle, during the compensation cycle the controller using the read signal to deactivate the second switch transistor to decouple the monitor line from the storage capacitor of the pixel circuit allowing the storage capacitor to discharge through the driving transistor of the pixel circuit during the compensation cycle.

7. The display system of claim 5 further comprising a third switch transistor shared by at least a first and a second pixel circuit of the one row, wherein the second switch transistor is shared by the at least a first and a second pixel circuit, wherein the controller programs the at least a first and a second pixel circuit during the programming cycle using the read signal for the one row for controlling the shared second switch transistor for coupling the monitor line with the storage capacitors of the at least a first and a second pixel circuit, wherein the controller further is for driving each pixel circuit over a plurality of operation cycles including an emission cycle after the programming cycle, during the emission cycle the controller using an emission signal line to control the third switch transistor to couple the driving transistors of the at least a first and a second pixel circuit to the first reference potential.

8. The display system of claim 4 wherein the controller programs the pixel circuit during the programming cycle of the first circuit using a write signal for the one row for controlling a first switch transistor for coupling a data line with the storage capacitor of the pixel circuit and for controlling a second switch transistor for coupling a monitor line with the storage capacitor of the pixel circuit, wherein the control signal used for controlling the programming of the another pixel is a write signal for the another row.

9. The display system of claim 8 further comprising a third switch transistor shared by at least a first and a second pixel circuit of the one row, wherein the second switch transistor is shared by the at least a first and a second pixel circuit, wherein the controller further is for driving each pixel circuit over a plurality of operation cycles including an emission cycle after the programming cycle, during the emission cycle the controller using an emission signal line to control the third switch transistor to couple the driving transistors of the at least a first and a second pixel circuit to the first reference potential.

10. A method of driving a display system, the display system including an array of pixel circuits arranged in rows and columns, each pixel circuit including:
a driving transistor;
a storage capacitor coupled across a gate terminal and a first terminal of the driving transistor;
a light emitting device coupled to a second terminal of the driving transistor; and
a reset switch transistor coupled between a first reference potential and a node common to a first terminal of the storage capacitor and the gate terminal of the driving transistor; the method comprising:
driving each pixel circuit during each frame over a plurality of operation cycles for the pixel circuit including a programming cycle and a reset cycle, comprising:
during the programming cycle, programming the storage capacitor of the pixel circuit, and
during a reset cycle prior to the programming cycle, resetting the driving transistor of the pixel circuit by activating the reset switch transistor of the pixel circuit during the reset cycle to expose the node of the pixel circuit to the reference potential which causes reverse biasing across the gate and first terminal of the driving transistor.

11. The method of claim 10 wherein resetting the driving transistor comprises activating the reset switch transistor of the pixel circuit with a control signal used for controlling a programming of another pixel circuit during the programming cycle of the another pixel circuit.

12. The method of claim 11 wherein the pixel circuit is of one row other than another row of the another pixel circuit.

13. The method of claim 12 wherein the one row and the another row are adjacent rows.

14. The method of claim 13 further comprising, programming the pixel circuit during the programming cycle using a write signal for the one row for controlling a first switch transistor for coupling a data line with the storage capacitor of the pixel circuit and using a read signal for the one row for controlling a second switch transistor for coupling a monitor line with the storage capacitor of the pixel circuit, wherein the control signal used for controlling the programming of the another pixel circuit is one of a write signal and a read signal for the another row.

15. The method of claim 14 wherein the plurality of operation cycles includes a compensation cycle and a settling cycle, wherein driving each pixel circuit further comprises after the programming cycle, during compensation cycle, deactivating the second switch transistor using the read signal to decouple the monitor line from the storage capacitor of the pixel circuit allowing the storage capacitor to discharge through the driving transistor of the pixel circuit during the compensation cycle.

16. The method of claim 13 further comprising, programming the pixel circuit during the programming cycle using a write signal for the one row for controlling a first switch transistor for coupling a data line with the storage capacitor of the pixel circuit and for controlling a second switch transistor for coupling a monitor line with the storage capacitor of the pixel circuit, wherein the control signal used for controlling the programming of the another pixel is a write signal for the another row.

17. A display system comprising:
an array of pixel circuits arranged in rows and columns, each pixel circuit including:
a driving transistor;
a storage capacitor coupled across a gate terminal and a first terminal of the driving transistor;
a light emitting device coupled to a second terminal of the driving transistor; and
a switch transistor coupled between a reference voltage and a node common to a first terminal of the storage capacitor and the first terminal of the driving transistor; and
a controller for driving each pixel circuit during each frame over a plurality of operation cycles for the pixel circuit including a programming cycle for programming the storage capacitor of the pixel circuit, and a reset cycle prior to the programming cycle for resetting the driving transistor of the pixel circuit, the controller resetting the driving transistor of the pixel circuit by activating the switch transistor of the pixel circuit during the reset cycle to expose the node of the pixel circuit to the reference voltage which is set to a voltage to cause reverse biasing across the gate and first terminal of the driving transistor.

18. The display system of claim 17 wherein the controller programs the pixel circuit during the programming cycle of the pixel circuit by deactivating the switch transistor, activating a first switch transistor for coupling a data line with the storage capacitor and the gate terminal of the driving transistor of the pixel circuit and activating a second switch transistor for coupling a controllable reference potential with the node of the pixel circuit.

19. The display system of claim 18 wherein the controller further is for driving each pixel circuit over a plurality of operation cycles including a compensation cycle and a settling cycle after the programming cycle, during the compensation cycle the controller deactivating the second switch transistor to decouple the controllable reference potential from the node of the pixel circuit allowing the storage capacitor to discharge through the driving transistor of the pixel circuit during the compensation cycle.

20. A method of driving a display system, the display system including an array of pixel circuits arranged in rows and columns, each pixel circuit including:
a driving transistor;
a storage capacitor coupled across a gate terminal and a first terminal of the driving transistor;
a light emitting device coupled to a second terminal of the driving transistor; and
a switch transistor coupled between a reference voltage and a node common to a first terminal of the storage capacitor and the first terminal of the driving transistor; the method comprising:
driving each pixel circuit during each frame over a plurality of operation cycles for the pixel circuit including a programming cycle and a reset cycle, comprising:
during the programming cycle, programming the storage capacitor of the pixel circuit, and
during a reset cycle prior to the programming cycle, resetting the driving transistor of the pixel circuit by activating the switch transistor of the pixel circuit during the reset cycle to expose the node of the pixel circuit to the reference voltage which is set to a voltage to cause reverse biasing across the gate and first terminal of the driving transistor.

21. The method of claim 20 further comprising, programming the pixel circuit during the programming cycle by deactivating the switch transistor, activating a first switch transistor for coupling a data line with the storage capacitor and the gate terminal of the driving transistor of the pixel circuit, and activating a second switch transistor for coupling a controllable reference potential with the node of the pixel circuit.

22. The method of claim 21 wherein the plurality of operation cycles includes a compensation cycle and a settling cycle, wherein driving each pixel circuit further comprises after the programming cycle, during the compensation cycle, deactivating the second switch transistor to decouple the controllable reference potential from the node of the pixel circuit allowing the storage capacitor to discharge through the driving transistor of the pixel circuit during the compensation cycle.
